(19) United States
(12) Patent Application Publication
(10) Pub. No.: US 2003/0175369 A1
(43) Pub. Date: Sep. 18, 2003

(54) Natural moths repellent compositions

(75) Inventor: Donna Khazan-Enache, North Brunswick, NJ (US)

Correspondence Address: Raymond E. McCreary, 233 Clifton Blvd., Clifton, NJ, 07015, US

(73) Assignee: Paragon Household Products Inc., Clifton, NJ

(21) Appl. No.: 10/079,122

(22) Filed: Feb. 19, 2002

(51) Int. Cl. A01N 25/00; A01N 65/00

(52) U.S. Cl. 424/739; 424/745; 424/747; 424/778; 424/770

(57) ABSTRACT

This present invention details slow-release natural and safe compositions for use in repelling clothes moths and other insects from all types of closed storage units. Specifically, the compositions contain a blend of Generally Regarded as Safe (GRAS) essential oils and some of their active ingredients, used currently as food additives including but not limited to, geranium oil, rosemary oil, peppermint oil, mint oil, citronella oil, thyme oil, cinnamon oil, geraniol, and eugenol. More specifically, the compositions further contain citric acid and acetic acid, all applied to a substrate.

### CROSS-REFERENCE TO RELATED APPLICATIONS

### U.S. Patent Documents

U.S Pat. No. 3,227,609 January 1966 Wilson et al. 514/762

U.S Pat. No. 4,379,168 April 1983 Dotolo 424/460

U.S Pat. No. 5,556,881 September 1996 Marisi 514/557

### OTHER REFERENCES

The Terpenes, Vol. 1, J. L. Simonsen and L. N. Owen, University Press, Cambridge, 1947

The Essential Oils, E. Guenther, Van Nostrand, USA, 1948

Essential Oils, B. M. Lawrence, Allured Publishing Co., Wheaton, USA, 1978

Vapor Toxicity and Repellency of Some Essential Oils to Insect Pests, S. M. Ahmed et al., Indian Perfumer, 30(1), pp.273-278, 1986

Lecture Notes on Essential Oils, Eve Taylor Ltd., USA, 1989

Essential Oils: The Illustrated Encyclopedia, United Press, UK, 1995

### FEDERALLY SPONSORED RESEARCH OR DEVELOPMENT

Not Applicable

### BACKGROUND OF INVENTION

Insect control, for both, the protection of crops and animals, and for maintenance of public health, has required much study and efforts over the years. It is estimated that more than 15% of the food man produces annually is eaten by insects. Insects are equally damaging in and around the homes, as many insect species live in this type of setting. Some of these household insects, such as flies, mosquitoes, fleas, cockroaches may function as vectors for contagious diseases. Others, such as clothes moth, tapestry moth, and carpet beetles are directly and constantly interfering with the quality of our lives, being responsible sometimes for a dramatic increase in the cost of living.

Three main methods of chemically controlling and/or repelling insect pests are known and used: stomach poisons, contact poisons and fumigants. Until recently, there was less concern about the possible adverse effects of these chemicals on humans and the environment, thus, little attention was paid to the toxicity of organic and inorganic materials employed to control and repel insects. Today, virtually all insect repellents and insecticides presently registered with the U.S. Environmental Protection Agency (EPA) must bear warnings, prohibiting or restricting their use on food, near food or in food-serving places, or in and around the homes. Many of these chemical insect control agents are toxic to humans and to pets if ingested, inhaled or dermally contacted. Thus, there is a great demand for natural, non-toxic, safer and environmentally-friendly pesticides, equal in efficacy to the toxic ones presently available on the market.

One area of interest is in the development and production of environmentally safe and non-toxic insect repellents is the use of Generally Regarded as Safe (GRAS) food additives. Many essential oils are approved as food flavoring additives in foods eaten by humans (21 CFR, Part 170-199, Food and Drug Administration (FDA), dated Apr. 1, 1990, incorporated herein by reference), and is similarly listed in the internationally recognized FOOD CHEMICALS CODEX (3^{rd} ed.) (incorporated herein by reference). A key requirement for determining the GRAS status of a substance is that safety information about the substance, including safety to humans and the environment, is available in the scientific literature for public review. Furthermore, the FDA has determined under 21 CFR Part 25.24(a)(8) that GRAS substances do not individually or cumulatively have a significant adverse effect on humans and/or the environment.

The regulations addressing the determining criteria for the GRAS status of a substance provide under 21 CFR Parts 170(a) and (b) clarifications concerning the chief requirements for a substance to qualify as GRAS. These regulations specify that a GRAS substance must be “environmentally safe”, safety which includes a reasonable “biodegradability” feature as well. The Module 19 of the 21 CFR Parts 172-186, contains a complete listing of essential oils accepted by FDA as GRAS substances. The compositions of this present invention contain a blend of essential oils such as peppermint oil, mint oil, geranium oil, rosemary oil, citronella oil, cedar oil, thyme oil, as well other substances present on the Module 19 Listing used as food additives, such as vanillin, citric acid or acetic acid.

It is well known that insects breathe by means of tubes (vents) that open on the body surface in spiracles. These tubes divide into very fine branches leading to all insect organs. Generally, the spiracles are water repellent, but oily solutions may enter them. Thus, many insect repellents contain oily solutions, or some contain essential oils. Insects have peripheral chemoreceptors neurons, located primarily on their antennae, legs, and abdomen. These chemoreceptors are activated in the presence of oily solutions or essential oils, practically determining the insect not to land on or in the vicinity of such surfaces.

The natural repellency and insecticidal properties of the above mentioned GRAS substances have been well documented for many years in scientific journals and publications (Vapor Toxicity and Repellency of Some Essential Oils to Insect Pests, S. M. Ahmed et al., Indian Perfumer, 30(1), pp. 273-278, 1986); The Essential Oils, E. Guenther, Van Nostrand, USA, 1948; Essential Oils: The Illustrated Encyclopedia, United Press, UK, 1995; Lecture Notes on Essential Oils, Eve Taylor Ltd., USA, 1989). For instance, citronella oil, along with many other essential oils, is a well-known and widely used insect repellent. The primary component responsible for its repellent properties is β-citronellol, which is member of the class of compounds known as “terpenes” (The Terpenes, Vol 1, J. L. Simonsen and L. N. Owen, University Press, Cambridge, 1947). Geranium oil, is well know for its insect repellent, insecticidal, fungicidal, and antimicrobial properties (Essential Oils, B. M. Lawrence, Allured Publishing Co., Wheaton, USA, 1978).

Many U.S. Patents teach similar lessons. For example, the U.S. Pat. No. 3,227,609 teaches the use of alpha-n-alkyl-butyrolactone, gamma-butyrolactone and/or of delta-valerolactone, also used a food flavorings, as anti-mating compositions or as insect repellents. Similarly, the U.S. Pat. No. 4,379,168 taught about the usefulness of using citronella oil and d-Limonene and its terpenes as insect repellents. The U.S. Pat. No. 5,556,881 teaches about compositions containing aqueous solutions of acetic acid and at least one essential, which may include spearmint oil, peppermint oil, mint oil, lemon oil, and sesame oil.

To date, compositions exhibiting a long-term repellent characteristics, made of all natural ingredients which are not toxic to humans, pets, and their environment have not been available. Thus, with the ever increasing public concern regarding short- and long-term possible health effects of harsh chemical repellents, the need of a natural repellent of clothes moth insects and other insects associated with closed storage units is clearly defined.

### SUMMARY OF THE INVENTION

It is the object of this invention to provide a slow-release process for repelling clothes moth insects and other insects present in closed storage units attracted by an odor emitted from a locus. This present invention further provides an environmentally-friendly, and non-toxic insect repellent process for repelling clothes moth insects and other insects from all types of closed storage units. This present invention also provides a method for repelling clothes moth insects and other insects using a slow-release factor. The slow-release moth insect repellent comprises one or another insect repellent composition contacting a substrate. The slow-release insect repellent compositions are prepared by a method comprising applying the insect repellent composition or compositions on to the substrate.

The method for repelling moth insects and/or other insects comprises placing the slow-release insect repelling product in an area where the insects may be present. The insect repellent composition or compositions used in the slow-release moth repellent product is prepared by mixing a repellent compound, a slow-release agent or agents and, optionally, a solvent to form a precursor composition or compositions which then is applied to a substrate and dried if necessary to form the moths and/or other insects natural repellent. Other additives such as agents to control the release rate and/or wetting agents may also be used. The repellent compound may be chosen from a group consisting of essential oils and active ingredients of essential oils. Essential oils are defined as any of a class of volatile oils obtained from plants and possessing the odor and characteristics of the plant. The slow-release agent or agents may contain compounds which may be natural also.

The slow-release moth insect repellent composition is beneficial because it contains natural ingredients only, its active ingredients are safe to be used with food, tobacco, and other consumable items, and the fragrance or fragrances of the ready-to-use final product is pleasant to most who come into contact with it. Further benefit is that the product remains active for the desired period of time which may be variable—short to long. The ingredients of this composition or compositions are non-toxic to humans, animals, and also biodegradable, thus, environmentally-friendly.

### DETAILED DESCRIPTION OF THE INVENTION

The composition or compositions of this present invention comprise mixtures of geranium oil, mint oil, peppermint oil, clove oil, thyme oil, cinnamon oil, rosemary oil, wintergreen oil and cedar oil, in addition to several other additives serving either as slow-release agent or agents, solvents, binders, and or substrate. The individual components of the compositions of the present invention are readily available commercially. This present invention also provides a natural insect repellent which has a pleasant fragrance, eliminating the need to air-out clothes after storage.

The present invention teaches that the rate of release of the vapor of the compound having the ability to repel insects may be adjusted by the addition of a slow-release agent. Mixing a repellent compound with a slow-release agent or agents in which the active ingredients are miscible allows a slow-release of the vapors of the active ingredients in some cases because of the affinity of the slow-release agent or agents for the active ingredients. Altering the relative ratios of the repellent active ingredients and the slow-release agent or agents in the moth insect repellent composition or compositions and/or choosing the type, amount and grade of active ingredients (e.g., essential oils) and inactive (e.g., slow-release agent, solvent, substrate) will allow for more particularized control of the release rate.

The slow-release moth insect repellent composition or compositions of this present invention are prepared by mixing a repellent compound with a slow-release agent or agents, a solvent, and/or other additives to form a precursor mixture, and then applying the precursor mixture to a substrate. Preferably, after the application of the precursor mixture to the substrate, the precursor mixture-substrate mix is dried before packaging takes place. The temperature of drying is not believed to be important, but the temperature ranges which may be used are in the range of from about 17° C. to about 37° C., preferably about 22° C. to about 27° C.

Examples of repellent compounds are essential oils such as citronella oil, geranium oil, mint oil, peppermint oil, clove oil, thyme oil, cinnamon oil, rosemary oil, rose oil, chamomile oil, orange oil, grapefruit oil, lemon oil, wintergreen oil, and cedar oil. Examples of active ingredients in essential oils are citronellal, citronellol, safrole, geraniol, eugenol, methyl salicilate, and D-limonene. The preferred moth repellent compound may contain geranium oil, mint oil, peppermint oil, clove oil, thyme oil, cinnamon oil, rosemary oil and wintergreen oil, cedar oil, and/or some of their active ingredients.

The concentration of the repellent compound in the moth insect repellent composition after the insect repellent composition or compositions have been applied and dried on the substrate will range from about 0.1 wt. % to about 80 wt. %, preferably about 0.1 wt. % to about 60 wt. %, most preferably from about 0.1 wt. % to about 45 wt. % (dry weight), with the balance of the moth insect repellent compound being the amounts of slow-releasing agent or agents, solvent, and/or other additives.

Examples of the substrates upon which the precursor mixture may be applied include but are not limited to materials such as paper, paperboard, peanut shells, polyethylene pellets, rice hulls, soybeans hulls, and/or soy protein. Preferably, the substrate and the precursor mixture may be packaged in individual containers or packages. Examples of containers and/or packages may include but not limited to sacks, bags, sachets, flexible packages, and/or molded fibers.

Examples of methods by which the precursor mixture may be prepared include but are not limited to the following: in standard laboratory beakers equipped with magnetic stirring bar, or in stainless steel mixing tanks equipped with mechanical agitation system(s) the powdered components of the composition matter(s), are added to essential oils and/or their active ingredients and stirred or mixed until the powders are completely dissolved. Examples of powdered components may include, but not limited to, vanillin. The remaining components, including but not limiting to, slow-release agent or agents, solvent, and other additives are then introduced in a predetermined order and mixed thoroughly to prepare the desired precursor mixture. The time necessary for agitation/mixing ranges from about 0 minutes to about 180 minutes, preferably from about 0 minutes to about 120 minutes, most preferably from about 0 minutes to about 45 minutes.

Examples of methods by which the substrate of the slow-release moth insect repellent may be coated with the precursor mixture include but are not limited to spray nozzle, rod coater, blade coater, roll coater, multiple roll transfer, controlled and uncontrolled rip, wet bath dip, curtain shower, and vacuum and non-vacuum impregnation. Printing methods which may be used with the invention formulation may be gravure, flexographic, screen, letterpress, web offset, sheetfed offset, and ink jet.

The practice of the invention may be illustrated by the following examples, which are not considered limiting:

### EXAMPLE 1

The relative percentages of the ingredients of the composition of matter object of this invention's precursor mixture are represented by (dry) weight in Table 1.

TABLE 1

| Component | Weight Percent |
|---|---|
| geranium oil | 4.00 |
| rosemary oil | 13.80 |
| citronella oil | 4.50 |
| thyme oil | 8.10 |
| cinnamon oil | 4.80 |
| cedar oil | 13.10 |
| geraniol | 2.10 |
| vanillin | 4.10 |
| 2-phenethyl propionate | 1.00 |
| citric acid | 1.10 |
| acetic acid | 1.10 |
| vegetable oil | 42.30 |

### EXAMPLE 2

The relative percentages of the ingredients of the composition of matter object of this invention's precursor mixture are represented by (dry) weight in Table 2.

TABLE 2

| Component | Weight Percent |
|---|---|
| peppermint oil | 20.20 |
| mint oil | 12.10 |
| citronella oil | 4.15 |
| clove oil | 3.10 |
| wintergreen oil | 10.22 |
| eugenol | 4.20 |
| geraniol | 1.55 |
| geranium oil | 2.34 |
| 2-phenethyl propionate | 1.10 |
| citric acid | 1.00 |
| acetic acid | 1.00 |
| vegetable oil | 40.04 |

From the foregoing descriptions, one of ordinary skill in the art may easily ascertain the essential characteristics of this invention and, without departing from its spirit or scope, may make various changes and modifications in the invention to adapt it to various usages and conditions.

1. What I claim as my invention is a slow-release insect repellent process for repelling clothes moths and other insects from all types of closed storage units, comprising an insect repellent composition contacting a substrate; wherein the insect repellent composition comprises (a) a repellent compound chosen from the group consisting of essential oils accepted as food additives and/or active ingredients of said essential oils, (b) slow-release agent or agents, and (c), a solvent; wherein the repellent compound used, while pleasantly fragranced, is not toxic to humans, animals and the environment.

2. The slow-release insect repellent composition of claim 1 wherein the repellent compound is consisting of a blend of essential oils and/or their active ingredients chosen from a group consisting of geranium oil, rosemary oil, citronella oil, and thyme oil.

3. The composition of claim 2 further comprising cinnamon oil, cedar oil, peppermint oil, mint oil, clove oil, and wintergreen oil.

4. The composition of claim 3 wherein present in the insect repellent compound is present in the insect repellent composition before application to the substrate in an amount in the range of from 0.1 to about 60% by weight.

5. The composition of claim 3 wherein present in the insect repellent compound is present in the insect repellent composition after application to the substrate and drying in the amount of from 0.1 to about 45% by weight

6. The composition of claim 1 further comprising 2-phenethyl propionate, geraniol, eugenol, and vanillin.

7. The composition of claim 6 further comprising citric acid and acetic acid.

8. The composition of claim 7 further wherein the slow-release agent comprises a slow evaporating vegetable oil.

9. The slow-release insect repellent composition of claim 1 wherein the substrate is chosen from a group consisting of paper, paperboard, peanut shells, polyethylene pellets, rice hulls, soybeans hulls, and soybean protein.

10. The slow-release insect repellent composition of claim 9 wherein the substrate comprises rice hulls.

11. The slow-release insect repellent composition of claim 10 wherein the substrate contacts the insect repellent compound for a pre-determined time, after which is dried at a temperature ranging from 17° C. to about 37° C.

12. The slow-release insect repellent composition of claim 11 is placed in a sachet.

13. A method for repelling clothes moths and other insects comprising placing the slow-release insect repellent composition in closets, garment bags, drawers, and/or in any other closed storage unit.
